(19) United States
(12) Patent Application Publication
(10) Pub. No.: US 2005/0018435 A1
(43) Pub. Date: Jan. 27, 2005

(54) Portable utility light

(76) Inventors: Tom V. Selkee, Claremont, CA (US); Rick J. Miali, Monrovia, CA (US)

Correspondence Address: Boniard I. Brown, #113, 1500 West Covina Parkway, West Covina, CA, 91790-2793, US

(21) Appl. No.: 10/860,089

(22) Filed: Jun. 2, 2004

Related U.S. Application Data
(60) Provisional application No. 60/477,986, filed on Jun. 11, 2003.

(51) Int. Cl. F21V 29/00

(52) U.S. Cl. 362/427; 362/240; 362/267; 362/294

(57) ABSTRACT

The present invention relates to portable battery utility lights and comprising light-emitting diodes on a casing pivotally mounted on a body containing battery and circuitry and system to power the LEDs. The LEDs are preferably encased in polymer or the like for resistance to damage by impact, vibration, abrasion, and environmental conditions.

### RELATED APPLICATIONS

Reference is made to our Provisional Application No. 00/477,986, filed Jun. 11, 2003, entitled “Portable Utility Light.”

### BACKGROUND OF THE INVENTION

The present invention generally relates to portable, battery powered, compact pivoting case utility lights, in particular to an LED based utility light. The case is pivotally mounted on a body which comprises a marker light substantially according to U.S. Pat. No. 6,461,017 to Selkee, which body contains a battery power source, light-emitting diode power control circuitry, and control switches, preferably in a fluid-tight configuration.

Portable utility lights that can be moved around in tight locations to aid the user to obtain the best lighting conditions are well known and commonly applied by workers who require a supplemental lighting source in challenging locations where large utility lights are difficult or impossible to maneuver, creating sharp shadows that obscure details. The utility light is liquid tight and extremely resistant to damage caused by impacts, intense vibration and rough handling when used in applications such as in emergency conditions (e.g., traffic accidents, earthquakes, tornadoes, floods, etc.) and for use during heavy equipment repair when the utility lights ate subjected to vibration and impact loads created by heavy equipment operation, frequent drops, and direct exposure to the elements such as rain, industrial chemicals and dust, plus an occasional impact with a motor vehicle tire or falling wrench. More particularly, it relates to such utility lights wherein one or more light emitting diodes (LED) lights, and a structural protective member with an integral wiring harness delivering power to the LEDs, are encapsulated by molding a transparent or semi-opaque impact resistant elastomeric polymer casing around them. The LEDs used in the utility light may vary in color (white, red, orange, yellow, blue, green.) depending on the lighting application desired. Red LEDs may be used in a flashing mode to alert others to a dangerous situation, while white LEDs provide extra light in a confined space work environment. The pivoting casing with integral molded lenses produces an intense and uniform wide lighting radiance pattern and the pivot assembly provides the light-emitting casing, an unlimited angular resolution by utilizing a friction based detent pivot member.

1. Field of the Invention

The present invention relates to portable, compact, battery powered utility lights with a pivoting light source body utilizing light emitting diodes (LEDs) encased in a polymer to make the LEDs liquid-tight and resistant to damage caused by impacts, heavy vibration, abrasive conditions and exposure to extreme environmental elements.

2. Description of the Prior Art

Host utility lights currently utilize short life span incandescent bulbs as the primary means for producing light. Incandescent bulbs require high wattage for operation due to their inefficient nature of energy to light conversion, as most energy is wasted in heat. Most incandescent type lights and the newer LED based utility lights have a removable transparent plastic cover or screen to protect the incandescent type bulb or LEDs and to allow bulb replacement, and thus are not sealed to be completely water or dust proof. The transparent cover may be surrounded by a protective screen or cage to prevent damage from impacts as demonstrated in U.S. Pat. No. 6,176,592 to Kovacik, et al. This screen or cage, while preventing impact damage, reduces the overall light output and creates uneven light patterns. Utility lights with incandescent filament type bulbs have a reduction in bulb life when exposed to vibration, water and impacts encountered in heavy industrial use. Filament lamps have many drawbacks such as high power consumption, the generation of large amount of heat and easy filament breakage. Existing utility lights are constructed of semi-rigid plastics and light metals, which are not inherently flexible, have low izod impact strengths, and thus demonstrate a propensity to sustain permanent damage during impacts. Incandescent type utility lights are also large and bulky due to the inner housing design which generally utilizes a metal carrier to hold the hot bulb and acts as a heat sink while also providing a means for bulb retention and replacement. The metal carrier that secures the bulb has a tendency to corrode over time due to water condensation in the bulb housing. Some prior art utility lights have a head which supports a light source that pivots relative to the body. The construction of such a utility light is complicated due to electrical connections between the light source and the batteries as the head pivots 180° or more relative to the body.

The present invention provides an improved utility light without the problems described.

### BRIEF DESCRIPTION OF THE DRAWINGS

FIG. 1 is a perspective view of a preferred embodiment of the present invention;

FIG. 2 is a top view of the utility light of FIG. 1;

FIG. 3 is a sectional view taken at line 3-3 in FIG. 2;

FIG. 4 is an exterior top view of the casing of FIG. 5;

FIG. 5 is a top view of the utility light of the invention in section illustrating a wire harness;

FIG. 6 is a top view of the utility light body;

FIG. 7 is a side elevational view of the utility light;

FIG. 8 is a top view of the utility light body with battery cover removed;

FIG. 9 is a side view of the utility light body with battery cover removed;

FIG. 10 is a top view of the utility light battery cover;

FIG. 11 is a side view of the utility light battery cover;

FIG. 12 is a side view of the utility light body with battery cover removed;

FIG. 13 is a partial top view of the utility light elastomeric lamp casing;

FIG. 14 is a block diagram of the light-emitting diode (LED) drive circuitry of the utility light;

FIG. 15 is a first embodiment of a schematic diagram of the utility light block diagram of FIG. 14; and

FIG. 16 is a second embodiment of a schematic diagram of the utility light block diagram of FIG. 14.

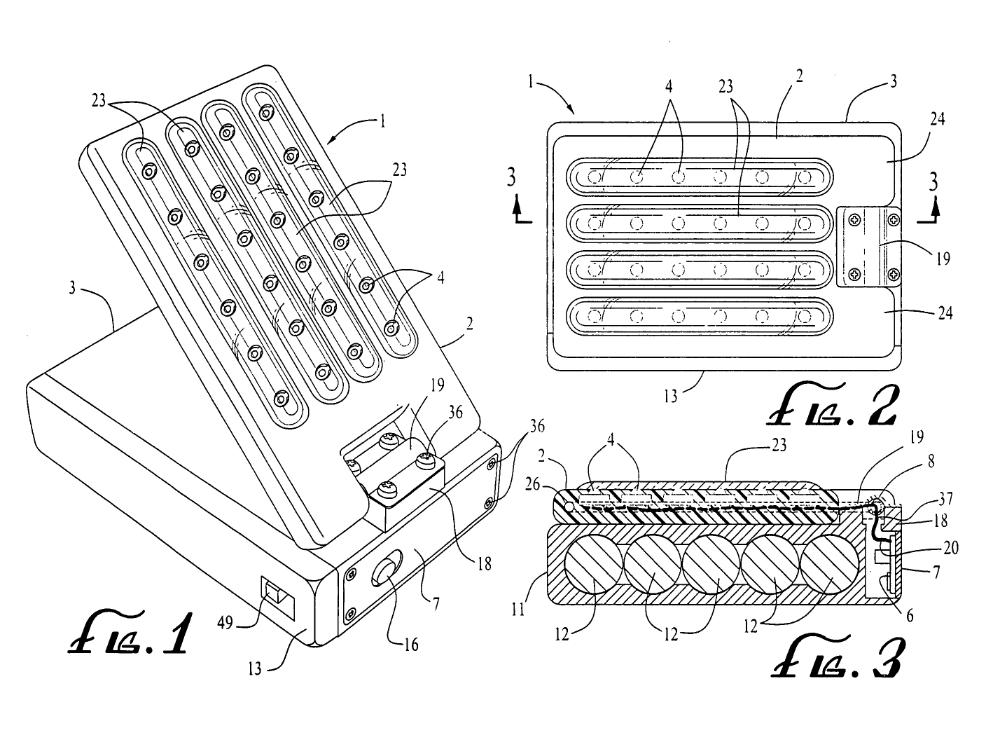

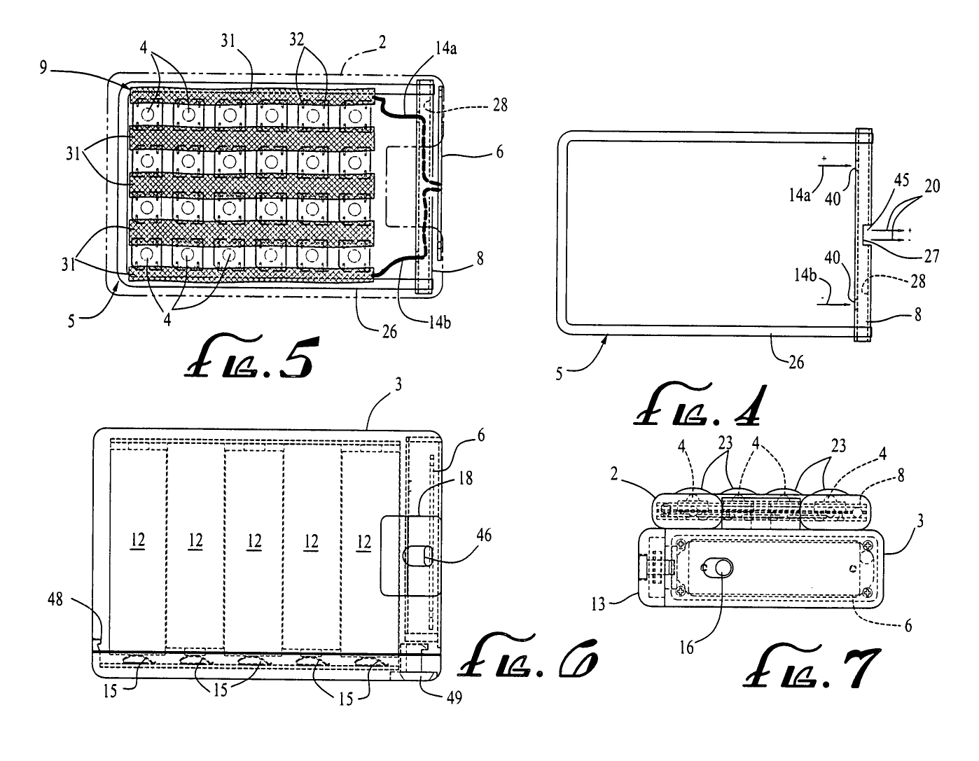

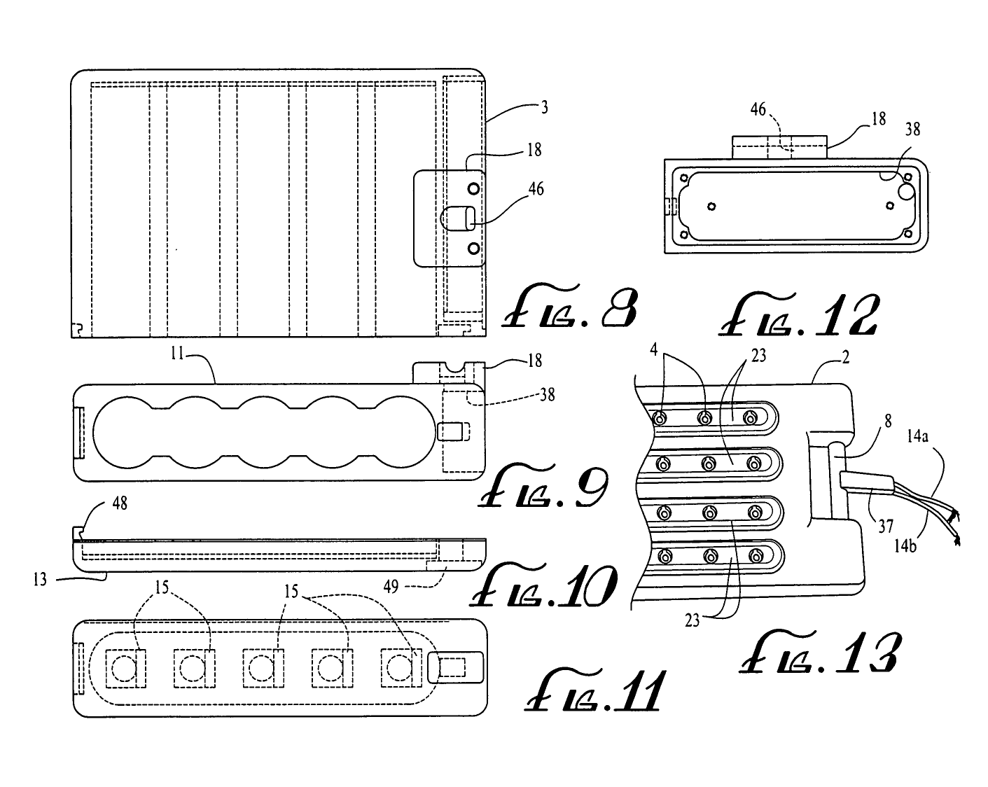

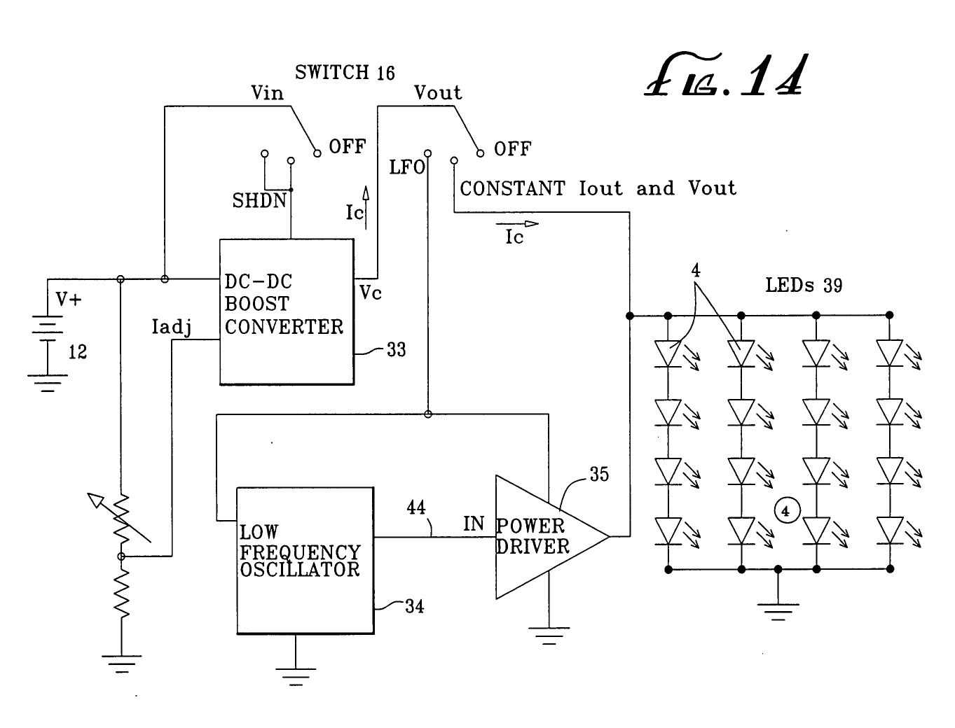

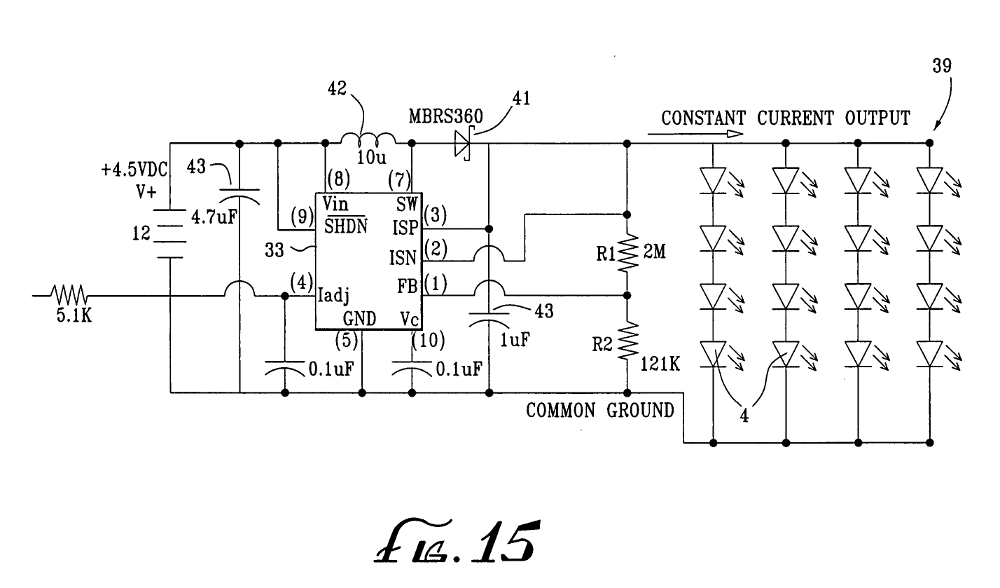

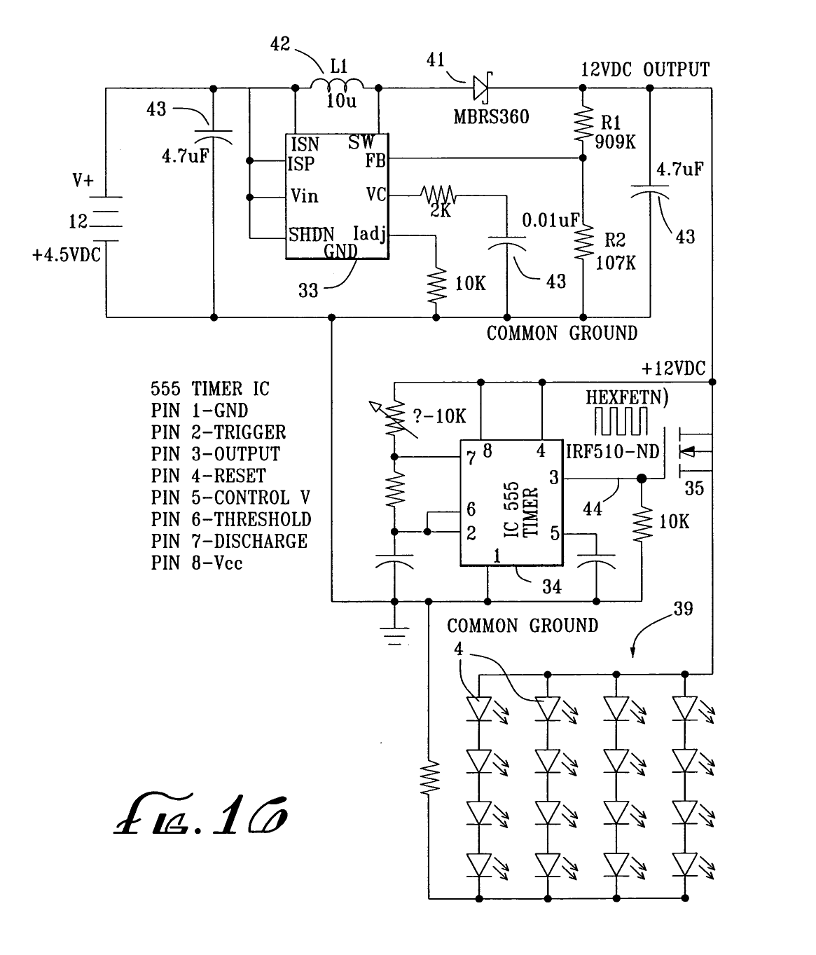

### DESCRIPTION OF THE PREFERRED EMBODIMENT

The utility light of the invention includes a body 3 which can be made of light metal alloys such as die cast zinc, magnesium or aluminum or high impact strength plastic injection molded polymers such as acrylonitrile butadiene styrene (ABS), nylon, polycarbonate, polyurethane and acetal. The body 3 includes a substantially rectangular housing 11, a pivot pin housing 18, which may be molded integral or removably secured to the rectangular housing 11. A liquid tight battery cover 13 is removably secured to the rectangular housing 11 to contain batteries 12. The battery cover 13 may be attached to the rectangular housing 11 utilizing a combination latch 48 and sliding catch mechanism 49. The body 3 also includes a recessed pocket 38 to house the light emitting diode (LED) power control circuit board 6. An elastomeric lamp casing 2 is rotationally fitted to the pivot pin housing 18 using a pivot pin 8 insert molded into one longitudinal end of the elastomeric lamp casing 2.

A pivot pin cover 19 constructed from stamped, corrosion resistant stainless steel is attached to the pivot pin housing 18 with screws 36 or snap type fastening means not shown. The pivot pin 8, compressed between the pivot pin housing 18 and the pivot pin cover 19, provides rotational elastomeric lamp casing 2 movement with controlled frictional torque between the body 3 and the pivot pin 8 central longitudinal axis.

The rectangular housing 11 encloses dry cell alkaline or rechargeable batteries 12 such as metal hydride, nickel cadmium or lithium types. Spring type electrically conductive contracts 17 mounted to the battery cover 13 urge the batteries into electrical contact with the LED power control circuit board 6. A double pole, triple throw (2P3T) power control switch 16 electrically connected to the LED power control circuit board 6, includes “Off,” “Steady On” and “Flash” modes. The “Steady On” mode provides a bright uniform continuous LED 4 light output. The Flash mode generates an intensely bright, eye catching flashing light signal that is easily perceived by the human eye. A slide or rotary thumb control type potentiometer 25 electrically connected to the LED power control circuit board 6 may be used to adjust both the “Steady On” and “Flash” mode light intensity outputs.

The elastomeric lamp casing 2 contains LEDs 4 connected to a flexible wiring harness assembly 9 that is insert molded into the injection molded thermoplastic elastomeric lamp case 2 with integral molded in lenses 23 to provide light convergence or divergence. The wiring harness assembly 9 includes a pair of laterally spaced apart, opposite chargeable, insulated multi-stranded conductors 20 that run longitudinally through the pivot pin 8 that has both oppositely opposed longitudinal ends insert molded into the two elastomeric lamp case ends 24. Positive and negative conductors 20 enter into the pivot pin 8 hollow center portion 28 through oppositely opposed holes 40 near both longitudinal ends of the pivot pin 8. The positive and negative conductors 20 exit the pivot pin 8 at the slotted center portion 45 and enter into the decreasing tapered slot 46 in the pivot pin housing 18. The decreasing tapered slot 46 captures the elastomeric lamp casing wire strain relief 37 that passes through the tapered slot 46 and enters into the recessed pocket 38 of the body 3 providing a liquid tight seal.

During insert injection molding, all voids in the pivot pin 8, including the slotted center portion 45, are filled with flexible elastomeric polymer. The elastomer surrounding the positive and negative conductors 20 provides strain relief 37 and resilient high fatigue life flexure of the conductive elements 10 during elastomeric lamp casing pivot pin 8 rotation. The positive and negative conductors 20 have positive and negative uninsulated portions 14a (positive) and 14b (negative) that are terminals for conduction of electricity and are attached to the LED power control circuit board 6. The positive and negative conductors 20 are used to transmit electricity from the LED power control circuit board 6 to the LED wire harness 9 and are electrically attached to the LED power control circuit board 6 using solder, mechanical crimp type terminals or welding processes (not shown). The pivot pin 8 is a slotted, headless, hollow cylindrical tube having a longitudinal slot down its entire length with chamfered or radiused ends. The pivot pin 8 is used in a compressed state to apply a continuous radial pressure towards the pivot; pin housing 18 and the pivot pin cover 19 thus providing consistent frictional torque to hold the elastomeric lamp casing 2 at any rotational angle with respect to the body 3 without using ratchet type mechanical detents. The pivot pin 8 is constructed from stainless steel to provide strength, corrosion and wear resistance. A LED 4 protective structure 5 consisting of a solid or tubular U-shaped rectangular structural member may surround the outer perimeter of the elastomeric lamp casing 2. The two ends of the U-shaped structural member 25 may be formed (bent) inwards and inserted into both open ends of the pivot pin 8. Staking, crimping or welding (not shown) of both longitudinal inward formed ends of the rectangular U-shaped structural member 26 to the pivot pin 8 longitudinal ends provides for a rigid non-dismountable structural whole, protecting the LEIs 4 from impacts and excessive bending loads. An alternate embodiment provides for a semi-rigid high durometer polymer, partially surrounding the LEDs 4 to obtain structural properties that prevent excessive elastomeric casing 2 deflection during sustained or impact loading conditions. A second more flexible lower durometer polymer is used to encase the LEDs 4 and attenuate large impact loads.

The LEDs 4 are electrically connected together in series-parallel combination 39 to form a matrix array by using spot welding, crimp type connections or wave soldering techniques depending on the type of LED 4 used. LEDs suitable for this purpose include Lullabied LUXEON, superflux or standard T1-3/4 type products. A flat braided copper LED conduction strip 31 is attached to the LED terminal leads 29 by solder joints 32 or crimp joints (not shown). The wiring harness assembly 9 is designed to be a thermal heat sink for the LED terminal leads 29 to maximize heat transfer from the LEDs 4. There are many methods to electrically connect and structurally protect the LEDs 4 and these are but two examples that maximize the thermoplastic shot size used to mold the case 2 while minimizing the insert molded wiring harness volume to obtain high impact energy absorption characteristics while minimizing the utility light 1 weight. The wiring harness 9 is coated with adhesives (not shown) to provide an interlocking bond between the adhesives and the thermoplastic elastomer during insert molding. The adhesive to thermoplastic elastomer bond prevents the wiring harness 9 from microscopically separating from the thermoplastic elastomer during case 2 flexure. This improves the overall utility light 1 structural dynamics by elimination or reduction of fatigue at contact points. Shock loads are more uniformly distributed over the entire wiring harness 9 thus making the utility light 1 less susceptible to sudden damaging impact loads. The adhesive layer also adds cushioning and creates an additional protective moisture barrier between the LEDs 4 and the case 2. A two part adhesive system utilized to provide rubber tearing bonds and outstanding environmental resistance are Chemlock 219 and 213 manufactured by Lord Chemical Products. Chemlock 219 can be used as a primer for Chemlock 213 adhesive as their properties are complementary. When using a two-coat system, optimum bond performance requires pre-baking of the wiring harness 9 before insert molding. Pre-bake can be as long as 16 hours at 250 F or as high as 325 for 2 hours when used with 219 as a primer. But it should be appreciated that the operating parameters of the method for each system should be adjusted empirically to optimize the overall utility light 1 performance. The case 2 can be molded from polyether, polyester or aliphatic based thermoplastic polyurethane's (TPU) with polyester based TPUs offering excellent toughness and resistance to oils and chemicals, polyether based TPUs offer excellent flexibility, hydrolytic stability and low temperature properties while aliphatic types offer outstanding optical clarity and resistance to yellowing, crazing and polymer chain degradation under extreme ultraviolet light exposure such as direct sunlight. Multi-slot injection molding techniques allow different durometer and types of resins to be utilized in combinations to form a variable durometer case 2 that has areas differing in hardness, flexibility and optical characteristics to optimize LED 4 protection while allowing increased flexure in areas designed to absorb impact energy. Common TPUs that can be used include Pellethane by Dow Chemical, Texim by Bayer Plastics or Tecoflex by Thermedics Polymer Products. Tecoflex thermoplastic elastomers are the preferred polymers for industrial lighting applications due to their balance of chemical/oil resistance, ultraviolet light protection, and toughness over temperature extremes, ease of processing and refractive indexes that are similar to traditional lens materials such as polycarbonate. The thermoplastic elastomers are injection molded at temperatures lower than the thermal distortion temperature of the LEDs 4. Injection molding process parameters are dependent on mold design and the type of injection molding process used and thus must be optimized for each application. The thermoplastic elastomer case 2 can be molded from pigmented and tinted TPUs that diffuse the intense focused LED 4 light, producing a wider viewing angle and a more uniform light distribution while also producing a utility light 1 that matches the color of the body 3. Complete light attenuation on one side of the case 2 can be achieved by adding a substantial amount of pigments. The LED 4 radiation pattern can be directed with lenses 23 molded into the case 2 to provide a uniform light Output over wide viewing angles. Lens 23 types such as pillow, fresnel and convex can be molded into the case 2 to provide diverging optics. An ideal drive circuit will provide the same current to the LEDs 4 regardless of ambient temperatures and battery 12 voltage variances.

Prior art battery based LED drive systems utilize series resistors for current limiting, when driving two or more LEDs 4 connected in series in each branch of parallel LEDs, see for example U.S. Pat. No. 5,907,569 to Glance, et al. The power loss in the series resistor, besides decreasing battery life, is converted into heat that must be properly dissipated. A main objective of the control circuitry used to drive the series-parallel LED combination 39 is to provide a constant direct current output to the LEDs 4 to achieve a constant light output instead of a high frequency pulsed light output that is achieved by utilizing a combination of both high and low frequency pulse width modulation drive techniques as described in U.S. Pat. Nos. 5,313,188 to Choi, et al and 6,329,760 to Bebenroth.

Pulsed light output may introduce problems when the utility light 1 is used for industrial applications such as checking machinery timing or moderate speed photographic video recording applications. When energized with electricity, LEDs 4 maintain a voltage drop (LED forward voltage) of approximately 1.5-4.0 volts depending on the LED light wavelength output and the material types used to fabricate the LEI)s. Performance testing to sort and categorize LEDs 4 according to luminous flux (light output), dominant light output wavelength (color), and forward voltage at their rated drive current provide matched bundled LEDs 4 with similar electrical and photonic characteristics to the end user.

As a general rule, most people cannot easily discern dissimilar light outputs of adjacent LEDs if their luminous intensity ratio is less than 2:1. LEDs 4 connected electrically in a series parallel combination that have similar electrical and photonic properties, help simplify the LED power control circuitry design to obtain uniform light output from all LEDs while maximizing power conversion efficiency to increase battery life.

The LED drive circuit in a battery-operated system must be capable of maintaining a constant current flow through the LEDs 4 for a wide range of battery 12 voltage input levels. The constant current LED drive circuitry 47 comprises a voltage controlled current source 1c coupled to a series-parallel combination of LEDs 39. The current source 1c provides an indication signal in response to the amount of current flowing into the LEDs 4. A controller circuit receives the indication signal and provides the appropriate control feedback signal to the current source 1c so that the current and voltage supplied to the LEDs 4 remains constant.

The LEDs 4 are driven by a drive circuit that utilizes a step Up or boost type DC/DC converter 33 to increase the battery voltage V+ to a level greater than the combined forward voltages of LEDs 4 arranged in a series-parallel connection configuration 39. The boost DC/DC converter 33 combines a traditional voltage feedback loop and a unique current feedback loop to operate at a constant-current 1c, constant voltage Vc source to the LEDs. The Linear Technology LT618 boost DC-DC converter 33 uses a constant frequency, current Lode control scheme to provide excellent line and load regulation. The constant output voltage Vc may be adjusted using the equation R1=R2 (Vout/1.263-1) and setting the values of resistors R1 and R2 to obtain the proper constant output voltage Vc. The LT1618 fixed frequency, current mode switcher operates from a wide direct current input voltage range (1.6V to 18V) and the 1.4 megahertz switching frequency allows the use of miniature, low profile inductors 42, diodes 41 and capacitors 43 to provide a compact small footprint LED power control circuitry 6. The LT1618 may be turned on and off by applying battery voltage to the SHDN pin.

A small, economical low current rated switch 16 may be used to control power input to the LEDs 4. The output current of the LT1618 may be adjusted by providing a variable voltage input, to the Iadj pin. Pulse width modulation (PWM) resistor capacitor combination input (not shown) or a voltage divider circuit to the LT1618 current adjustment Iadj pin may be used to adjust the LED 4 brightness. Schottky diodes 41 with their low forward voltage drop and fast switching speed are used for the LED power control circuitry 6. Ferrite core inductors 42 should be used to obtain the best efficiency, as their core losses in the megahertz switching frequency are mulch lower than powdered iron inductors. The inductor 42 should have a low DCR (copper-wire resistance) to minimize power losses. Low equivalent series resistance multi-layer ceramic capacitors 43 should be used at the output to minimize the power supply output ripple voltage and at the power supply input as a decoupling capacitor 43. X5R and X7R capacitor dielectrics are preferred as these materials retain their capacitance over wider voltage and temperature ranges than other dielectrics.

Another function of the LED power control circuitry 6 is to provide an intense flashing light signal in frequencies ranging from 1 to 10 Hz. The output of the DC-DC boost converter 33 is electrically connected to a low frequency oscillator LFO 34 providing a gating signal 44 that is fed directly into the power driver 35. The power driver 35 may be a solid-state power switch such as a power MOSFET or HEXFET with a small drain to source on resistance to minimize power losses. The details of the low frequency oscillator 34 are not depicted since many oscillator configurations may be used for this purpose and the construction of such oscillators will be well within the capabilities of those ordinarily skilled in the art. Oscillator designs based upon the NE555 impulse generator, 8-bit microprocessor with pulse width modulated output or discrete transistors may be used to minimize power consumption and obtain low manufacturing and procurement costs.

It is to be understood that various changes and modifications may be made from the preferred embodiments discussed above without departing from the scope of the present invention, which is established by the following claims and equivalents thereof.

1. A utility light comprising:
a casing,
a plurality of light-emitting diodes disposed on the casing, and
a body to which said casing is pivotally mounted, said body containing a battery power source, power control circuitry for light-emitting diodes, and control switches operationally connected with said light-emitting diodes on the casing.

2. A utility light according to claim 1 and further comprising heat sink means in the casing.

3. A utility light according to claim 1 wherein said casing and body are fluid-tight.

4. A utility light according to claim 1 and further comprising heat sink means in said casing for heat generated by the light-emitting diodes.

5. A utility light according to claim 1 wherein said casing is elastomeric.

6. A utility light according to claim 1 wherein the light-emitting diodes are embedded in the casing.

7. A utility light according to claim 1 wherein said power source comprises at least one positive and one negative electrical connector extending from said body to the casing.

8. A utility light comprising:
an elastomeric casing having a plurality of light-emitting diodes mounted therein,
a body,
a plurality of electroconductive elements in said casing and interconnecting said light-emitting diodes, said electroconductive elements providing a heat sink for heat generated by said light-emitting diodes,
at least one substantially rigid portion of said elastomeric casing adjacent to at least certain ones of said light-emitting diodes to shield the diodes against damaging impact and bending loads, and
an electrical power source connected with said electro-conductive elements to energize said light-emitting diodes.

9. A utility light according to claim 8 and further comprising heat sink means in the casing.

10. A utility light according to claim 8, wherein said casing and body are fluid-tight.

11. A utility light according to claim 8, wherein said casing is elastomeric.

12. A utility light according to claim 8, wherein the light-emitting diodes are embedded in the casing.

13. A utility light according to claim 8, wherein said power source comprises at least one positive and one negative electrical connector extending from said body to the casing.

14. A utility light comprising:
a casing having mounted therein a plurality of light-emitting diodes,
said casing being pivotally mounted on a body, said casing having substantially discrete portions of different durometer materials,
said polymer casing having a first inner core portion comprising substantially rigid thermoplastic material and a second outer portion disposed about said first inner core portion and comprised of thermoplastic elastomeric material,
a plurality of light-emitting diodes embedded in said casing first inner core portion,
a plurality of elongated electroconductive elements interconnecting the light-emitting diodes in said casing,
electrical input conductors extending into said casing and providing heat sink means for heat generated by the light-emitting diodes, and
an electrical power source connected with said electro-conductive elements to energize said light-emitting diodes.

15. A utility light according to claim 14 wherein said casing and body are fluid-tight.

16. A utility light according to claim 14 and further comprising heat sink means in said casing for heat generated by the light-emitting diodes.

17. A utility light according to claim 14 wherein said power source comprises at least one positive and one negative electrical connector extending from said body to the casing.
